(19) United States
(12) Patent Application Publication
(10) Pub. No.: US 2025/0229241 A1
(43) Pub. Date: Jul. 17, 2025

(54) Stirring Device with Cooling Function

(71) Applicant: LG Energy Solution, Ltd., Seoul (KR)

(72) Inventors: Jae Pil Koo, Daejeon (KR); Sung Jong Shin, Daejeon (KR); Woong Ju Bang, Daejeon (KR); Jae Huoung Son, Daejeon (KR)

(73) Assignee: LG Energy Solution, Ltd., Seoul (KR)

(21) Appl. No.: 18/841,139

(22) PCT Filed: Jul. 4, 2023
(86) PCT No.: PCT/KR2023/009363

§ 371 Date: Apr. 9, 2025

(30) Foreign Application Priority Data
Jul. 11, 2022 (KR) 10-2022-0085290

(51) Int. Cl. B01F 35/93; B01F 27/072; B01F 35/53; B01F 35/90; B01F 35/95

(52) U.S. Cl. CPC B01F 35/93; B01F 27/0724; B01F 35/53; B01F 35/95; B01F 2035/98

(57) ABSTRACT

A stirring device related to one example of the present invention comprises a stirring vessel including an inner chamber having a stirring space and an outer chamber surrounding the inner chamber, and having a vessel cooling space provided between the inner chamber and the outer chamber, a stirring part including a stirring rod disposed in the stirring space and provided to stir a stirring object accommodated in the stirring space, a plurality of cooling rods each protruding from the inner chamber of the stirring vessel into the stirring space, and connected to the vessel cooling space to enable fluid movement, and a cooling drive part provided to supply cooling water to the vessel cooling space.

### TECHNICAL FIELD

The present invention relates to a stirring device, which relates, specifically, to a stirring device with a cooling function, and relates, particularly, to a stirring device with a cooling function that can maintain the temperature of a stirring object at a constant level by cooling the heat generated during stirring.

This application claims the benefit of priority based on Korean Patent Application No. 10-2022-0085290 dated Jul. 11, 2022, the disclosure of which is incorporated herein by reference in its entirety.

### BACKGROUND ART

Secondary batteries are manufactured by performing sequentially an electrode manufacturing process, an electrode assembly process, and a formation step. Here, if the electrode manufacturing process is subdivided again, it can be classified into a slurry preparing process, a process of coating a slurry on a current collector, a rolling process, a slitting process, and a drying process.

The slurry is a substance in which an active material, a conductive agent, a binder, and a solvent are mixed, where the slurry is prepared by dry-mixing the active material and the conductive agent in a powder form, and then wet-mixing the active material and the conductive agent with the solvent in which the binder is dissolved.

Upon preparing the slurry, the raw materials of the slurry are put into a stirring device to be stirred.

FIG. 1 is a schematic diagram showing a conventional slurry stirring device.

Referring to FIG. 1, the conventional stirring device comprises a stirring vessel (10) and a stirring rod (20) disposed within the stirring vessel (10).

Also, the stirring vessel (10) is provided with a cooling flow passage (11). The cooling flow passage (11) is a space provided between the inner surface and the outer surface of the stirring vessel (10), where cooling water flows through the cooling flow passage (11). While the cooling water flows along the cooling flow passage (11), it cools the heat generated in a stirring space (12) of the stirring vessel (10).

Typically, the stirring rod (20) is disposed in the central portion of the stirring space (12), and the cooling flow passage (11) is provided at the outer portion of the stirring space (12).

For dispersion of the slurry upon a stirring operation of the slurry, the stirring rod (20) is rotated at high speed.

At this instance, upon rotation of the stirring rod (20) at high speed, the temperature of the slurry around the stirring rod (20) rapidly increases due to frictions between the stirring rod and the slurry.

As the cooling flow passage (11) is provided only at the outer portion of the stirring space (12), a temperature deviation of the slurry between the central portion of the stirring space (12) and the outer portion of the stirring space (12) occurs upon high-speed rotation of the stirring rod (20). That is, the temperature of the slurry in the central portion of the stirring space (12) rises, whereas the temperature of the slurry in the outer portion of the stirring space (12) lowers.

The slurry is a high-viscosity material, and as the temperature rises in the central portion of the stirring space (12) upon rotation of the stirring rod (20) at high speed, gelation of the slurry may occur in the central portion of the stirring space (12). At this instance, as the slurry in the central part of the stirring space (12) gelates, it does not mix with the slurry in the outer portion of the stirring space (12), there is a problem that the quality of the slurry deteriorates.

### DISCLOSURE

### Technical Problem

It is a problem to be solved by the present invention to provide a stirring device having a cooling function capable of resolving temperature deviation between a central portion and an outer portion of a stirring space.

Also, it is a problem to be solved by the present invention to provide a stirring device having a cooling function, provided so that a stirring object is stirred while forming vortexes by a stirring rod and a cooling rod upon rotation of the stirring rod, and the stirring object exchanges heat with cooling water in the entire region of central and outer portions of a stirring space.

In addition, it is a problem to be solved by the present invention to provide a stirring device having a cooling function capable of preventing gelation of a stirring object due to an increase in temperature around a stirring rod.

Furthermore, it is a problem to be solved by the present invention to provide a stirring device having a cooling function capable of uniformly maintaining the temperature of a stirring object in a stirring space through heat exchange between the stirring object and cooling water in the entire region of the stirring space, and improving a mixing efficiency of the stirring object.

### Technical Solution

In order to solve the above-described problem, a stirring device related to one example of the present invention comprises a stirring vessel including an inner chamber having a stirring space and an outer chamber surrounding the inner chamber, and having a vessel cooling space provided between the inner chamber and the outer chamber, a stirring part including a stirring rod disposed in the stirring space and provided to stir a stirring object accommodated in the stirring space, a plurality of cooling rods each protruding from the inner chamber of the stirring vessel into the stirring space, and connected to the vessel cooling space to enable fluid movement, and a cooling drive part provided to supply cooling water to the vessel cooling space.

Also, the plurality of cooling rods may be disposed apart from each other around the stirring rod, and may be provided so that upon stirring, the stirring object flows via peripheries of the stirring rod and the cooling rods.

In addition, the respective cooling rods may be disposed parallel to the axial direction of the stirring rod within the stirring space.

Furthermore, the cooling drive part may comprise a first cooling flow passage for supplying the cooling water to the vessel cooling space.

Also, the first cooling flow passage may be provided so that the cooling water supplied to the vessel cooling space goes through the vessel cooling space and each cooling rod.

In addition, the stirring rod may comprise a main body provided with a first space extending along the axial direction of the stirring rod, and a rotary wing coupled to the main body.

Furthermore, the cooling drive part may comprise a second cooling flow passage for supplying the cooling water to the first space.

Also, each cooling rod may have a second space connected to the vessel cooling space to enable fluid movement.

In addition, the plurality of cooling rods may be radially disposed apart from each other around the stirring rod, and the respective cooling rods may each be arranged in parallel with the stirring rod.

Furthermore, the cooling drive part may be provided to supply the cooling water to the vessel cooling space when the stirring rod rotates.

Also, a stirring device related to another example of the present invention comprises a stirring vessel including an inner chamber having a stirring space and an outer chamber surrounding the inner chamber, and having a vessel cooling space provided between the inner chamber and the outer chamber, a stirring part including a stirring rod disposed in the stirring space and provided with a first space therein, and provided to stir a stirring object accommodated in the stirring space, a plurality of cooling rods each protruding from the inner chamber of the stirring vessel into the stirring space, and connected to the vessel cooling space to enable fluid movement, and a cooling drive part including a first cooling flow passage provided to supply cooling water to the vessel cooling space and a second cooling flow passage for supplying the cooling water to the first space.

In addition, the plurality of cooling rods may be radially disposed apart from each other around the stirring rod, and the respective cooling rods may each be arranged in parallel with the stirring rod.

Furthermore, each cooling rod may have a second space connected to the vessel cooling space to enable fluid movement.

Also, the cooling drive part may be provided to simultaneously supply the cooling water to the first cooling flow passage and the second cooling flow passage.

In addition, the cooling drive part may be provided to supply the cooling water to one or more cooling flow passages of the first cooling flow passage and the second cooling flow passage when the stirring rod rotates.

### Advantageous Effects

As discussed above, the stirring device related to one example of the present invention has the following effects.

By disposing the plurality of cooling rods around the stirring rod disposed in the central portion of the stirring space and supplying cooling water to the cooling rods and the stirring rod, respectively, it is possible to resolve temperature deviation between the central portion and the outer portion of the stirring space.

Also, when the stirring rod rotates, the stirring object can be stirred while forming vortexes in a process of going through the stirring rod and the cooling rods; the stirring object can exchange heat with the cooling water in the entire region of the central portion and the outer portion in the stirring space, and around the stirring rod; and gelation caused by the temperature increase of the slurry can be prevented.

In addition, by maintaining the temperature of the stirring object upon stirring uniformly, it is possible to improve the mixing efficiency between the raw materials of the stirring object.

Furthermore, the cooling rods are disposed parallel to the axial direction of the stirring rod, and accordingly, it is possible to easily perform the cleaning of the stirring vessel after the stirring process of the stirring object.

### DESCRIPTION OF DRAWINGS

FIG. 1 is a schematic diagram showing a conventional slurry stirring device.

FIG. 2 is a diagram schematically showing a stirring device according to one example of the present invention.

FIG. 3 is a schematic perspective diagram of a stirring vessel constituting the stirring device shown in FIG. 2.

FIG. 4 is a schematic cross-sectional diagram in a state cut along line x-x of FIG. 3.

FIG. 5 is a schematic configuration diagram of a stirring device according to one example of the present invention.

FIG. 6 is a diagram for explaining one operating state of the stirring device shown in FIG. 2.

FIG. 7 is a diagram schematically showing a stirring device according to another example of the present invention.

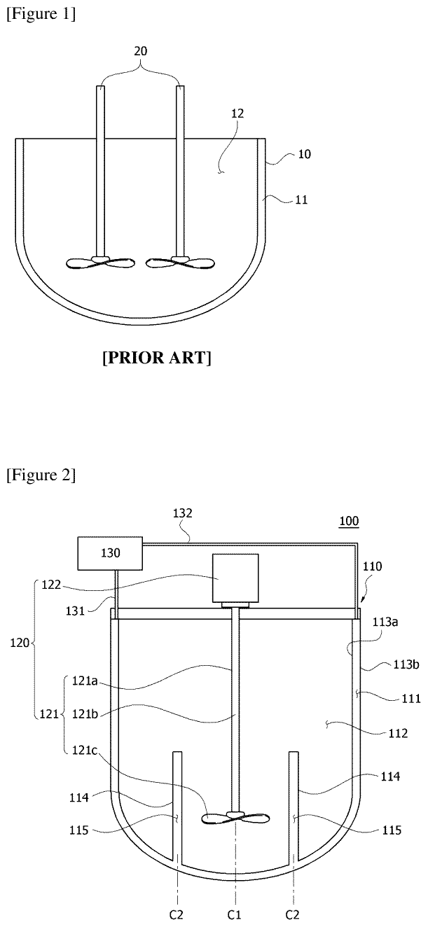

### MODE FOR INVENTION

Hereinafter, a stirring device having a cooling function according to one example of the present invention (hereinafter, abbreviated as ‘stirring device’) will be described in detail with reference to the drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

FIG. 2 is a diagram schematically showing a stirring device (100) according to one example of the present invention.

The stirring device (100) related to one example of the present invention comprises a stirring vessel (110) including an inner chamber (113a) having a stirring space (112) and an outer chamber (113b) surrounding the inner chamber (113a), and having a vessel cooling space (111) provided between the inner chamber (113a) and the outer chamber (113b).

Also, the stirring device (100) comprises a stirring part (120) including a stirring rod (121) disposed in the stirring space (112), and provided to stir a stirring object accommodated in the stirring space (112).

In addition, the stirring device (100) comprises a plurality of cooling rods (114) each protruding from the inner chamber (113a) of the stirring vessel (110) into the stirring space (112), and connected to the vessel cooling space (111) to enable fluid movement, and a cooling drive part (130) connected to the stirring vessel (110) and provided to supply the cooling water to the vessel cooling space (111).

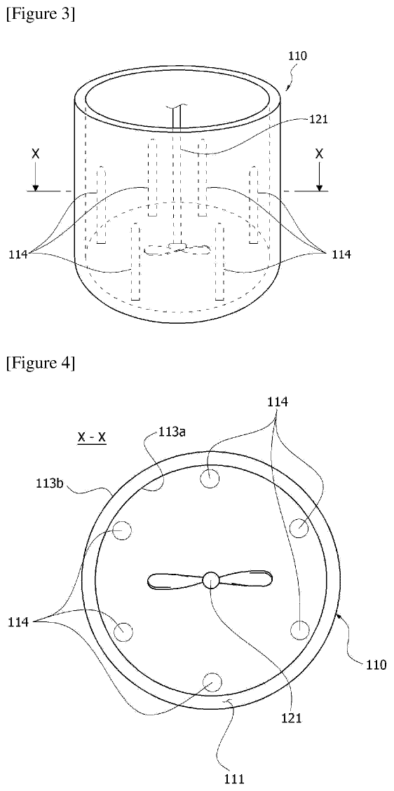

FIG. 3 is a schematic perspective diagram of a stirring vessel constituting the stirring device shown in FIG. 2, and FIG. 4 is a schematic cross-sectional diagram in a state cut along line x-x of FIG. 3.

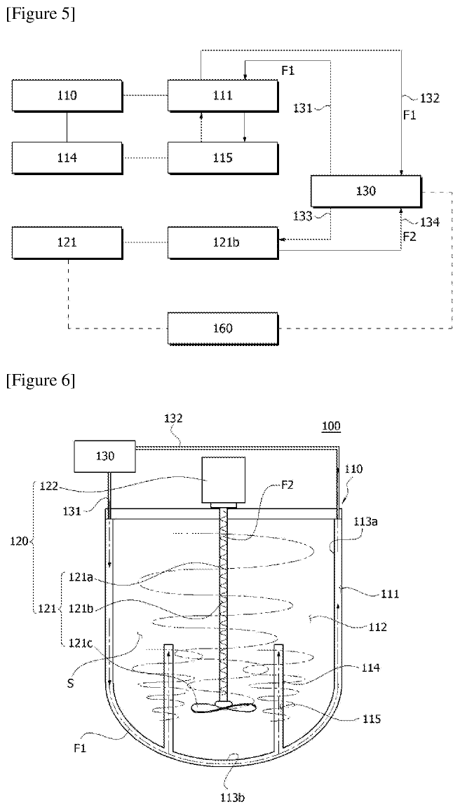

In addition, FIG. 5 is a schematic configuration diagram of a stirring device according to one example of the present invention, and FIG. 6 is a diagram for explaining one operating state of the stirring device shown in FIG. 2.

One example of the present invention provides a stirring device (100) for maintain the temperature of a stirring object (S) (see FIG. 6, raw materials of slurry) constant upon stirring by stirring the stirring object (S) and cooling heat generated during stirring.

Referring to FIGS. 2 to 6, the stirring device (100) comprises a stirring vessel (110), a plurality of cooling rods (114), a stirring part (120), and a cooling drive part (130).

The stirring vessel (110) is a vessel in which the stirring object (S) is stirred. The stirring vessel (110) is provided with a vessel cooling space (111) and a stirring space (112), respectively.

The stirring space (112) is provided in an inner chamber (113a) of the stirring vessel, and the stirring object (S) is accommodated in the stirring space (112). Also, a plurality of cooling rods (114) and a stirring rod (121) are disposed in the stirring space (112). Meanwhile, in FIG. 2, C1 represents the axial direction of the stirring rod (121), and C2 represents the axial direction of the cooling rod (114). In addition, the stirring rod (121) may be provided to rotate based on the axial direction. At this time, the respective cooling rods (114) may be arranged parallel to the axial direction of the stirring rod (121) within the stirring space (112). That is, the axial direction (C2) of the cooling rod (114) and the axial direction (C1) of the stirring rod are arranged in parallel.

In addition, the vessel cooling space (111) is a space provided between the inner chamber (113a) and an outer chamber (113b) of the stirring vessel. The vessel cooling space (111) is a space through which cooling water flows. The vessel cooling space (111) is provided to surround the internal chamber (113a) of the stirring vessel along the circumferential direction of the stirring vessel (110).

Each cooling rod (114) has a second space (115) with a hollow inside, where the second space (115) may be formed to extend along the axial direction (C2, longitudinal direction) of the cooling rod (114). Also, the second space (115) is connected to the vessel cooling space (111) to enable fluid movement. In addition, the second space (115) is a cooling flow passage branched from the vessel cooling space (111), where the cooling water flowing in the vessel cooling space (111) flows through the second space (115).

Also, the cooling drive part (130) may comprise a first cooling flow passage (F1) for supplying the cooling water to the vessel cooling space (111). At this time, the first cooling flow passage (F1) may be provided so that the cooling water supplied to the vessel cooling space (111) goes through the vessel cooling space (111) and the respective cooling rods (114).

In addition, the cooling drive part (130) may comprise one or more pumps for circulating cooling water in respective cooling flow passages, and a cooling device (chiller, etc.) for cooling the heat-exchanged cooling water.

Furthermore, the cooling drive part (130) may be provided to supply the cooling water to the vessel cooling space (111) when the stirring rod (121) rotates.

Also, the plurality of cooling rods (114) is arranged in parallel with the stirring rod (121) and extends parallel to the axial direction of the stirring rod (121) in the inner chamber (113a) of the stirring vessel (110). For example, the cooling rod (114) may be provided to protrude from the bottom surface of the inner chamber (113a) of the stirring vessel (110) along a direction parallel to the axial direction of the stirring rod (121), and may be provided to be disposed in the lower region of the stirring space (112).

Referring to FIGS. 3 and 4, the plurality of cooling rods (114) is each arranged in parallel with the stirring rod (121) and radially disposed apart from each other around the stirring rod (121). The plurality of cooling rods (114) is disposed apart from each other around the stirring rod (121), where the cooling water flowing in the vessel cooling space (111) may flow into each cooling rod (114). In such a structure, upon stirring, the stirring object may flow via the peripheries of the stirring rod (121) and the cooling rods (114).

Also, the plurality of cooling rods (114) guides flow of the cooling water supplied along the vessel cooling space (111) so that the cooling water flows toward the region around the stirring rod (121) in the stirring space (112).

In addition, the stirring part (120) may comprise at least one stirring rod (121), and a stirring motor (122) for rotating the stirring rod (121). The stirring motor (122) is coupled to the stirring rod (121) to provide a rotational force to the stirring rod (121).

The stirring rod (121) is disposed in the stirring space (112). The stirring part (120) is provided to stir the stirring object (S) accommodated in the stirring space (112).

Also, the stirring rod (121) may comprise a main body (121a) provided with a first space (121b) extending along the axial direction (C1) of the stirring rod (121), and a rotary wing (121c) coupled to the main body (121a).

In addition, the cooling drive part (130) may comprise a second cooling flow passage (F2) for supplying the cooling water to the first space (121b).

The stirring rod (121) may be connected to the cooling drive part (130) to enable fluid movement, and connected so that the cooling water is circulated, and may be provided so that the cooling water circulates the cooling drive part (130) and the first space (121b) through the second cooling flow passage (F2).

Also, the main body (121a) of the stirring rod (121) has a cylindrical structure with a hollow inside. The first space (121b) is a space provided in the main body (121a) in the axial direction (C1, also referred to as the longitudinal direction) of the main body (121a). The cooling water may flow through the first space (121b).

In addition, a stirring motor (122) providing a rotational force to the main body (121a) may be provided at the upper end of the main body (121a), and the main body (121a) may be connected to a cooling drive part (130) supplying the cooling water to the first space (121b) and recovering it therefrom.

Furthermore, the rotary wing (121c) may be provided at the lower end of the main body (121a). When the stirring motor (122) operates, the rotary wing (121c) stirs the stirring object (S) accommodated in the stirring space (112) while rotating together with the main body (121a).

The cooling drive part (130) comprises a first cooling flow passage (F1) provided so that the cooling water is supplied to the vessel cooling space (111) and the supplied cooling water is recovered.

The first cooling flow passage (F1) is provided so that the cooling water supplied to the vessel cooling space (111) exchanges heat with the stirring object in the stirring space (112) while going through the vessel cooling space (111) and the respective cooling rods (114), and the heat-exchanged cooling water is recovered.

Referring to FIGS. 2 and 5, as one example, the cooling drive part (130) may be connected to the stirring vessel (110) through a first pipe (131) and a second pipe (132).

The first pipe (131) is a pipe connecting the cooling drive part (130) and the stirring vessel (110), which is a pipe through which the cooling water flows from the cooling drive part (130) to the stirring vessel (110). In addition, the second pipe (132) is a pipe connecting the cooling drive part (130) and the stirring vessel (110), which is a pipe through which the heat-exchanged cooling water flows from the stirring vessel (110) to the cooling drive part (130).

In addition, the cooling drive part (130) comprises a second cooling flow passage (F2) provided so that the cooling water supplied to the first space (121b) in the stirring rod (121) is recovered to the cooling drive part (130).

The second cooling flow passage (F2) may be provided so that the cooling water supplied to the first space (121b) flows through the first space (121b) along the axial direction of the stirring rod (121), and the cooling water heat-exchanged with the stirring object around the stirring rod (121) while flowing through the first space (121b) may be recovered to the cooling drive part (130) through the second cooling flow passage (F2).

Also, the cooling drive part (130) may be connected to the stirring rod (121) through a third pipe (133) and a fourth pipe (134). The third pipe (133) is a pipe connecting the cooling drive part (130) and the stirring rod (121), which is a pipe through which the cooling water flows from the cooling drive part (130) to the stirring rod (121). In addition, the fourth pipe (134) is a pipe connecting the cooling drive part (130) and the stirring rod (121), which is a pipe through which the heat-exchanged cooling water flows from the stirring rod (121) to the cooling drive part (130).

In addition, the cooling drive part (130) is operated so that the cooling water is supplied to the first pipe (131) and the third pipe (133), and the heat-exchanged cooling water is recovered through the second pipe (132) and the fourth pipe (134).

The stirring device (100) may comprise a control part (160) controlling the stirring part (120) and the cooling drive part (130). The control part (160) is provided to operate the stirring part (120) and the cooling drive part (130), respectively, upon stirring.

Referring to FIGS. 5 and 6, the cooling water supplied from the cooling drive part (130) is heat-exchanged with the stirring object (S) in the stirring space (112) while flowing along the first cooling flow passage (F1) and the second cooling flow passage (F2).

Specifically, the cooling water supplied from the cooling drive part (130) flows into the vessel cooling space (111) through the first pipe (131). The cooling water is heat-exchanged with the stirring object (S) in the stirring space (112) while flowing through the vessel cooling space (111) and the second space (115) of the cooling rod (114) along the first cooling flow passage (F1). Thereafter, the heat-exchanged cooling water is recovered from the vessel cooling space (111) to the second pipe (132). The heat-exchanged cooling water may be cooled again in the cooling drive part (130) to be supplied to the vessel cooling space (111) through the first pipe (131).

Also, the cooling water supplied from the cooling drive part (130) flows into the first space (121b) through the third pipe (133). At this instance, the cooling water is heat-exchanged with the stirring object (S) in the stirring space (112) while flowing through the first space (121b) along the second cooling flow passage (F2). When the stirring rod (121) rotates, the cooling water is heat-exchanged with the stirring object (S) around the main body (121a) while flowing though the first space (121b) along the second cooling flow passage (F2) and the axial direction (C1) of the main body (121a). Thereafter, the heat-exchanged cooling water is discharged from the stirring rod (121), and recovered to the cooling drive part (130) through the fourth pipe (134).

In addition, the cooling water flowing along the vessel cooling space (111) is heat-exchanged with the stirring object (S) at the outer portion of the stirring space (112). Then, the cooling water flowing through the second space (115) and the first space (121b) is heat-exchanged with the stirring object (S) in the stirring space (112).

Furthermore, the stirring device (100) related to another example of the present invention comprises a stirring vessel (110) including an inner chamber (113a) having a stirring space and an outer chamber (113b) surrounding the inner chamber (113a), and having a vessel cooling space (111) provided between the inner chamber (113a) and the outer chamber (113b), a stirring part (120) including a stirring rod (121) disposed in the stirring space (112) and provided with a first space (121b) therein, and provided to stir a stirring object accommodated in the stirring space, a plurality of cooling rods (114) each protruding from the inner chamber (113a) of the stirring vessel (110) into the stirring space, and connected to the vessel cooling space to enable fluid movement, and a cooling drive part (130) including a first cooling flow passage (F1) provided to be connected to the stirring vessel (110) to enable fluid movement, thereby supplying the cooling water to the vessel cooling space (111) and a second cooling flow passage (F2) for supplying the cooling water to the first space.

Also, the stirring device (100) may comprise a control part (160) controlling the stirring part (120) and the cooling drive part (130). The control part (160) is provided to operate the stirring part (120) and the cooling drive part (130), respectively, upon stirring.

In the present example, the cooling drive part (130) may be provided to simultaneously supply the cooling water to the first cooling flow passage (F1) and the second cooling flow passage (F2). In addition, the cooling drive part (130) may be provided to supply the cooling water to one or more flow passages of the first cooling flow passage (F1) and the second cooling flow passage (F2) when the stirring rod (121) rotates. The operation of the cooling drive part (130) may be controlled by the control part (160).

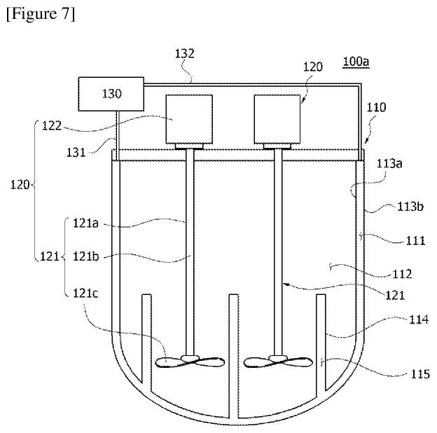

FIG. 7 is a diagram schematically showing a stirring device (100a) according to another example of the present invention.

Referring to FIG. 7, the stirring device (100a) comprises a stirring vessel (110), a plurality of stirring parts (120), a plurality of cooling rods (114), and a cooling drive part (130).

In the present example, the stirring vessel (110), the plurality of cooling rods (114), and the cooling drive part (130) are the same as the corresponding constitutions of the example described through FIGS. 2 to 6, and thus the descriptions thereof will be omitted.

In the present example, as the plurality of stirring parts (120) is provided, a plurality of stirring rods (121) is disposed in the stirring space (112) of the stirring vessel (110). The plurality of stirring rods (121) is disposed apart from each other side by side. In the present example, the second cooling flow passage (F2) may be provided for each stirring rod (121) of each stirring part (120).

Also, the plurality of cooling rods (114) may be disposed apart from each other between the stirring rods (121).

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to the stirring device related to one example of the present invention, it is possible to resolve the temperature deviation between the central part and the outer part of the stirring space.

1. A stirring device comprising:
a stirring vessel including an inner chamber having a stirring space and an outer chamber surrounding the inner chamber, and having a vessel cooling space provided between the inner chamber and the outer chamber;
a stirring part including a stirring rod disposed in the stirring space and provided to stir a stirring object accommodated in the stirring space;
a plurality of cooling rods each protruding from the inner chamber of the stirring vessel into the stirring space, and connected to the vessel cooling space to enable fluid movement; and
a cooling drive part provided to supply cooling water to the vessel cooling space.

2. The stirring device according to claim 1, wherein
the plurality of cooling rods is disposed apart from each other around the stirring rod, and provided so that upon stirring, the stirring object flows via peripheries of the stirring rod and the cooling rods.

3. The stirring device according to claim 1, wherein
the respective cooling rods are disposed parallel to the axial direction of the stirring rod within the stirring space.

4. The stirring device according to claim 1, wherein
the cooling drive part comprises a first cooling flow passage for supplying the cooling water to the vessel cooling space.

5. The stirring device according to claim 4, wherein
the first cooling flow passage is provided so that the cooling water supplied to the vessel cooling space goes through the vessel cooling space and each cooling rod.

6. The stirring device according to claim 1, wherein
the stirring rod comprises a main body provided with a first space extending along the axial direction of the stirring rod, and a rotary wing coupled to the main body.

7. The stirring device according to claim 1, wherein
the cooling drive part comprises a second cooling flow passage for supplying the cooling water to the first space.

8. The stirring device according to claim 1, wherein
each cooling rod has a second space connected to the vessel cooling space to enable fluid movement.

9. The stirring device according to claim 8, wherein
the plurality of cooling rods is radially disposed apart from each other around the stirring rod, and the respective cooling rods are each arranged in parallel with the stirring rod.

10. The stirring device according to claim 1, wherein
the cooling drive part is provided to supply the cooling water to the vessel cooling space when the stirring rod rotates.

11. A stirring device comprising:
a stirring vessel including an inner chamber having a stirring space and an outer chamber surrounding the inner chamber, and having a vessel cooling space provided between the inner chamber and the outer chamber;
a stirring part including a stirring rod disposed in the stirring space and provided with a first space therein, and provided to stir a stirring object accommodated in the stirring space;
a plurality of cooling rods each protruding from the inner chamber of the stirring vessel into the stirring space, and connected to the vessel cooling space to enable fluid movement; and
a cooling drive part including a first cooling flow passage provided to supply cooling water to the vessel cooling space and a second cooling flow passage for supplying the cooling water to the first space.

12. The stirring device according to claim 11, wherein
the plurality of cooling rods is radially disposed apart from each other around the stirring rod, and the respective cooling rods are each arranged in parallel with the stirring rod.

13. The stirring device according to claim 11, wherein
each cooling rod has a second space connected to the vessel cooling space to enable fluid movement.

14. The stirring device according to claim 11, wherein
the cooling drive part is provided to simultaneously supply the cooling water to the first cooling flow passage and the second cooling flow passage.

15. The stirring device according to claim 11, wherein
the cooling drive part is provided to supply the cooling water to one or more cooling flow passages of the first cooling flow passage and the second cooling flow passage when the stirring rod rotates.
